(19) United States
(12) Patent Application Publication
(10) Pub. No.: US 2016/0266781 A1
(43) Pub. Date: Sep. 15, 2016

(54) CUSTOMIZABLE MEDIA PLAYER CONTROLS

(71) Applicant: Microsoft Technology Licensing, LLC, Redmond, WA (US)

(72) Inventors: Srinivas Dandu, Bellevue, WA (US); Dmitriy Komin, Maple Valley, WA (US); Dibyajyoti Roy, Issaquah, WA (US)

(21) Appl. No.: 14/873,093

(22) Filed: Oct. 1, 2015

Related U.S. Application Data
(60) Provisional application No. 62/131,795, filed on Mar. 11, 2015.

(51) Int. Cl. G06F 3/0484

(52) U.S. Cl. CPC G06F 3/04847

(57) ABSTRACT

A facility for managing a media player is described. In one example facility, the facility discerns direction from an application program specifying a presentation of media player controls for the media player. Based at least in part on the discerning, the facility causes the media player to be displayed, including a visual user interface for the media player in which media player controls are presented in accordance with the discerned direction.

### CROSS-REFERENCE TO RELATED APPLICATION(S)

This application claims the benefit of U.S. Provisional Application No. 62/131,795, filed on Mar. 11, 2015, which is hereby incorporated by reference in its entirety. In cases in which a document incorporated by reference herein is inconsistent with contents of this application, the contents of this application control.

### BACKGROUND

Some application programs involve the playback of media resources, such as video and/or audio sequences. In developing such an application program, a developer typically has a choice between constructing a media player from scratch, or adapting an existing media player to needs of the application, such as by modifying the set of controls presented to a user by the existing media player.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for managing a media player is described. In one example facility, the facility discerns direction from an application program specifying a presentation of media player controls for the media player. Based at least in part on the discerning, the facility causes the media player to be displayed, including a visual user interface for the media player in which media player controls are presented in accordance with the discerned direction.

### BRIEF DESCRIPTION OF THE DRAWINGS

FIG. 1 is a block diagram showing some of the components that may be incorporated in at least some of the computer systems and other devices on which the facility operates.

FIG. 2 is a flow diagram showing example acts that may be performed by the facility in some examples to customize media player controls.

FIG. 3 is a display diagram showing media player controls in a first state.

FIG. 4 is a display diagram showing how the presented controls shown in FIG. 3 are altered when the application customizes the controls by changing the number of rows.

FIG. 5 is a display diagram showing the result of customizing the controls shown in FIG. 3 to remove the seek bar and add a playback rate button.

FIG. 6 is a table diagram showing sample contents of a custom control precedence table containing a precedence order for presenting controls specified by an application.

FIG. 7 is a display diagram showing media player controls presented in accordance with the precedence established in FIG. 6 and Table 5 when a relatively large amount of display space is available for controls.

FIG. 8 is a display diagram showing the presentation of media player controls in accordance with the control precedence shown in FIG. 6 and in Table 5 in a case where a relatively small amount of display space is available.

FIG. 9 is a display diagram showing the media player controls of FIG. 9 where the facility provides a secondary mechanism to present lower-precedence controls not presented among the main controls.

### DETAILED DESCRIPTION

The inventors note that both constructing a media player for an application from scratch and adapting an existing media player to needs of the application typically involve a substantial amount of coding, at a high level of sophistication. They have recognized this as a disadvantage of conventional approaches to incorporating a media player into an application program.

In response to this recognition, the inventors have conceived and reduced to practice a software and/or hardware facility for, under the control of an application program, programmatically customizing the controls presented by a media player (“the facility”). In some examples, these customized controls are presented in connection with the controlled media player's content area, such as immediately below the content area.

In various examples, the facility enables the application program to customize the controls presented by the media player by calling an API, by providing a modified template—such as a template in the XAML markup language or another markup language, or by using a simplified development tool such as WINJS.

In some examples, the facility and the media player whose controls it customizes are part of an operating system. In such examples, updates to the facility in media player that provide benefits to users of the application can be propagated to users of the application by the operating system's updating mechanism, allowing these users to enjoy benefits of these updates without having to update the application. In various other examples, the media player is updated in various other ways not requiring updating of the application.

In some examples, the facility enables the application program to toggle on and off various controls that have been implemented for the media player. In some examples, the facility enables the application program to specify how controls that have been implemented for the media player are arranged, such as in how many rows they are presented. In some examples, the facility enables the application program to specify a precedence order among the media player's controls, so that when the media player is constrained to a small display area (such as on a device whose total display area is small, or where the media player is using a small portion of a larger display area available on a device), the facility includes the high-precedence controls that fit, and omits the lower-precedence controls, and/or provides a secondary mechanism for the user to access the lower-precedence controls. In some examples, the facility enables the application program to customize the appearance and/or the look and feel of media player controls, such as to make the controls more consistent with the application's visual design, or brands associated with the application. In some examples, the facility enables the application to add additional buttons or controls of other types to the media player, and specify actions to be taken in response to the activation.

In some examples, the facility and the media player whose controls it customizes operate over a range of devices and device types, such as desktop and laptop computers, tablet computers, smartphones, wearables, gaming systems, televisions, virtual reality or augmented reality displays, etc., having a variety of screen sizes, screen aspect ratios, and screen area allocation schemes. In such examples, an application developer can use the facility to specify customization of the media player's controls once, and use the media player customized in this way across the full range of devices and device types on which the facility and the media player operate, in some cases to varying effect across different such device types and/or devices' state.

By behaving in some or all of the ways described above, the facility reduces the amount of effort and expertise needed to implement, as part of an application, a media player whose controls are adapted to the needs of the application. By utilizing a well-optimized media player as the basis of its customizations, the facility can reduce the amount of display space needed by a device to effectively control a media player; reduce processing resources needed to provide for control of a media player; and make certain visual user interfaces more intuitive and time-efficient to use, allowing a device to be powered on for a shorter period of time and consume a lower total amount of electrical energy overall.

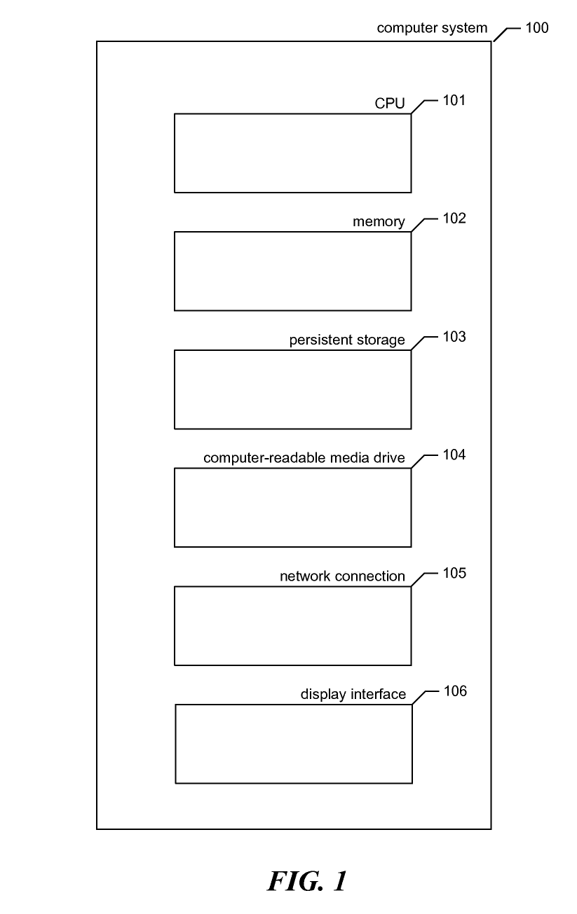

FIG. 1 is a block diagram showing some of the components that may be incorporated in at least some of the computer systems and other devices on which the facility operates. In various examples, these computer systems and other devices 100 can include server computer systems, desktop computer systems, laptop computer systems, tablet computer systems, netbooks, mobile phones, personal digital assistants, televisions, cameras, automobile computers, electronic media players, electronic kiosk devices, electronic table devices, electronic whiteboard devices, etc. In various examples, the computer systems and devices may include any number of the following: a central processing unit (“CPU”) 101 for executing computer programs; a computer memory 102 for storing programs and data while they are being used, including the facility and associated data, an operating system including a kernel and device drivers, and one or more applications; a persistent storage device 103, such as a hard drive or flash drive for persistently storing programs and data; a computer-readable media drive 104, such as a floppy, CD-ROM, or DVD drive, for reading programs and data stored on a computer-readable medium; a communications subsystem 105 for connecting the computer system to other computer systems and/or other devices to send and/or receive data, such as via the Internet or another wired or wireless network and its networking hardware, such as switches, routers, repeaters, electrical cables and optical fibers, light emitters and receivers, radio transmitters and receivers, and the like; and/or a display interface 106 through which the device can cause visual information such as a media player, media player controls, and media player content to be displayed on one or more display devices such as LCD panels, LED or OLED panels, CRTs, video projectors, holographic projectors, retinal projectors, virtual reality or augmented reality displays, etc.

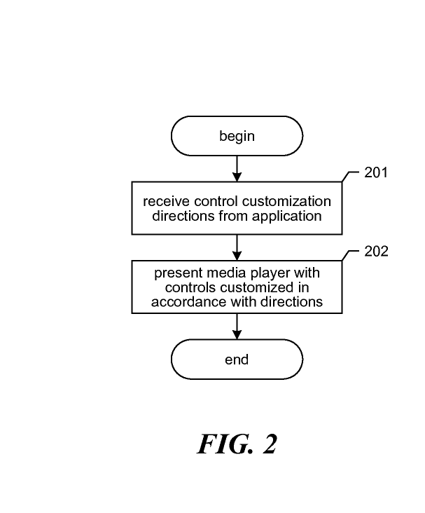

FIG. 2 is a flow diagram showing example acts that may be performed by the facility in some examples to customize media player controls. At 201, the facility receives control customization directions from the application, in various examples, this involves: being called by the application, such as via an API; reading a markup language template provided in connection with the application and/or executing code provided in connection with the application in a class derived from the MediaTransportControls class that specifies the action performed when a particular control is activated that specifies the appearance and behavior of particular controls; having data members of the facility or that are intermediate to the facility and the application set by the application; etc. In various examples, the customization directions received include, for example, toggling on and off optional controls; changing the number of rows in which the controls are arranged; a precedence order among controls that determines which will be displayed where a small display area is available for their display; etc. At 202, the facility presents a media player whose controls are customized in accordance with the directions received at 201. In some examples, this involves adapting the customized controls to conditions in which the media player is presented, including display device capability such as size and pixel density; device mode such as portrait or landscape orientation or tablet or laptop use mode; window size, full-screen mode, or other display layout detail; operating system-wide user interface artifacts such as soft navigation control buttons; etc. After 202, these acts conclude.

Those skilled in the art will appreciate that the acts shown in FIG. 2 may be altered in a variety of ways. For example, the order of the acts may be rearranged; some acts may be performed in parallel; shown acts may be omitted, or other acts may be included; a shown act may be divided into sub-acts, or multiple shown acts may be combined into a single act, etc.

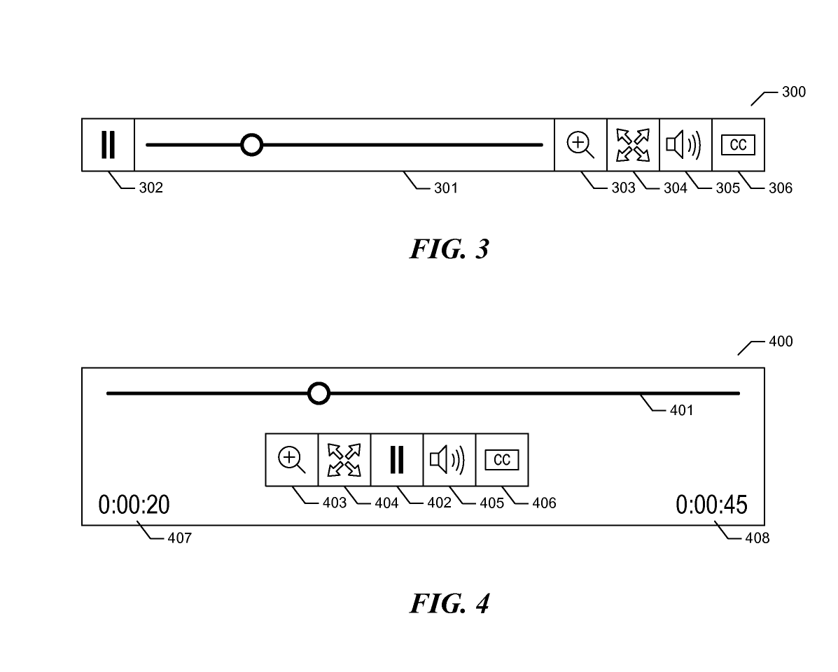

FIG. 3 is a display diagram showing media player controls in a first state. These controls 300 include: a seek bar 301 that indicates the current relative playback position in the media sequence by the position of a slider here shown as a circle, which the user can drag left or right to change the relative playback position; a play/pause button 302 that indicates whether the media sequence is presently being played or paused, and can be activated by the user to toggle this state; a zoom button 303 whose appearance indicates the level of visual zoom of video playback, and can be activated by the user to change this zoom level; a full window button 304 that the user can activate in order to use an entire available display space, such as the entire display area of the display device, to perform video playback; a volume/mute button 305 whose appearance indicates the current volume level for audio playback, and can be activated by the user in order to change this volume level; and a closed caption selection button 306 whose appearance indicates whether closed caption text is being displayed in connection with audio playback, and can be actuated by the user in order to alter the closed caption display state. It can be noted that, in FIG. 3, all of the visual controls 301-306 are displayed in a single horizontal row. In some examples, the application can customize the controls to change the number of rows in which they are arranged. Table 1 below shows sample C++ code that an application can execute in order to change the number of rows in which controls are displayed from one to two.

TABLE 1

1 auto myMediaElement = ref new MediaElement( );
2 myMediaElement->TranportControls->IsCompact = false;

It can be seen that, in line 2, the C++ code sets an IsCompact data member to false. An application may use a markup language such as XAML instead to effect this customization, as shown below in Table 2, which similarly sets an IsCompact data member to the value false in line 3.

TABLE 2

1 <MediaElement>
2 <MediaElement.TransportControls>
3 <MediaTransportControls IsCompact = “false”/>
4 </MediaElement.TransportControls >
5 </MediaElement>

FIG. 4 is a display diagram showing how the presented controls shown in FIG. 3 are altered when the application customizes the controls by changing the number of rows, such as is shown in Tables 1 and 2 above. It can be seen that the seek bar 401 is in a row of its own, enabling it to take advantage of the full width of the control area 400, making it longer than seek bar 301 shown in FIG. 3, and capable of greater precision in identifying current relative playback position in the media sequence. Buttons 402-406 are together in a second row, in which there is room for playback position time indication 407 and media sequence total length indication 408.

In some examples, the facility enables the application to toggle the controls that are presented with the media player. For example, relative to the controls shown in FIG. 3, the application may toggle off the seek bar 301, and toggle on a playback rate button not shown in FIG. 3. Table 3 below shows sample C++ code for toggling controls in this manner.

TABLE 3
1 auto tranportControl = ref new CustomMediaTransportControls ( );
2 transportControl->IsSeekBarVisible = false;
3 transportControl->IsPlaybackRateButtonVisible = true;
4 myMediaElement->TransportControls = transportControl;

It can be seen that, in line 2, the sample code shown in Table 3 sets a IsSeekBarVisible data member to false in order prevent the seek bar from being displayed. In line 3, an IsPlaybackRateButtonVisible data member is set to true in order to cause the playback rate button to be displayed.

Table 4 below shows corresponding sample XAML code for achieving the same result.

TABLE 4

| | |
|---|---|
| 1 | <MediaElement> |
| 2 | <MediaElement.TransportControls> |
| 3 | <local:CustomMediaTransportControls |
| | IsSeekBarVisible = “false” |
| | IsPlaybackRateButtonVisible = “true”/> |
| 4 | </MediaElement.TransportControls > |
| 5 | </MediaElement> |

It can be seen that, in line 3, two corresponding data members are set the same way.

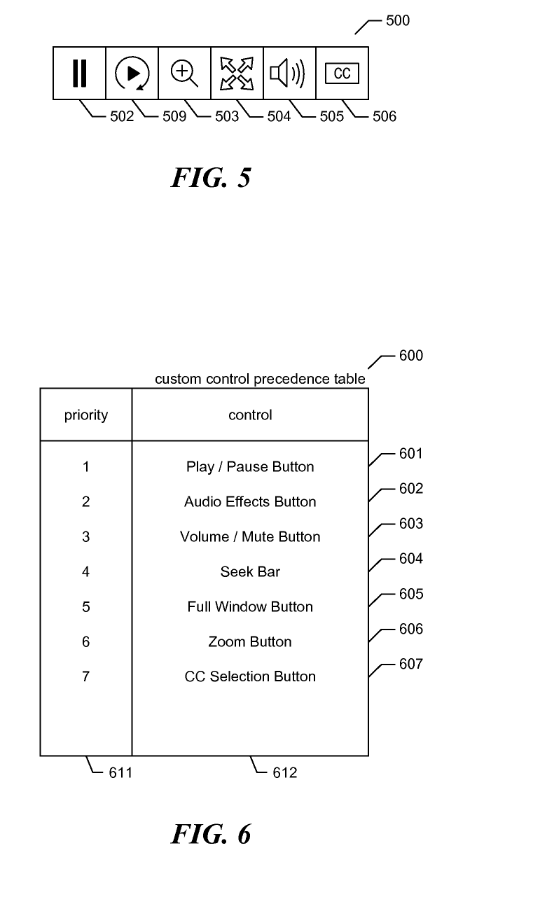

FIG. 5 is a display diagram showing the result of customizing the controls shown in FIG. 3 to remove the seek bar and add a playback rate button. It can be seen that, among controls 500, seek bar shown in FIG. 3 is not present, while playback rate button 509 has been added.

In some examples, the facility enables the application to specify a precedence order among media play controls that affects which controls are included with the media player at various display space allocation levels. For example, FIG. 6 is a table diagram showing sample contents of a custom control precedence table containing a precedence order for presenting controls specified by an application. The table 600 is made up of rows 601-607, each corresponding to a different control. In each row, a priority column 611 indicates a numerical priority for the control, while a control column 612 identifies the control. For example, row 601 indicates that a play/pause button has priority 1, i.e., the highest priority. After this precedence order for controls is specified by the application, the facility will include the controls with the highest precedence—the smallest priority values—until the space available for controls is exhausted. This specified preference order need have no relation to the layout of the controls, such that a button in the middle of the controls can have the lowest precedence, and thus drop out first, than a button at the right end of the controls can have the next-lowest precedence, and drop out next, etc. In some examples, the facility prevents certain essential controls from being omitted, such as the pause/play button. In some such examples, such essential controls can be reduced in size to occupy less space, where needed.

Table 5 below contains sample XAML code that can be used by the application to specify the precedence order shown in FIG. 6.

TABLE 5

| | |
|---|---|
| 1 | <Style TargetType=“MediaTransportControls”> |
| 2 | <ControlTemplate TargetType=“MediaTransportControls”> |
| 3 | ... |
| 4 | <CommandBar.PrimaryCommands> |
| 5 | <AppBarButton x:Name=‘PlayPauseButton’ |
| 6 | Icon=‘Play’ |
| 7 | Style=‘{StaticResource AppBarButtonStyle}’ |
| 8 | MediaTransportControlsHelper.DropoutPriority=‘1’ |
| 9 | VerticalAlignment=‘Center’/> |
| 10 | <AppBarButton x:Name=‘AudioEffectButton’ |
| 11 | Icon=‘Star’ |
| 12 | Style=‘{StaticResource AppBarButtonStyle}’ |
| 13 | MediaTransportControlsHelper.DropoutPriority=‘2’ |
| 14 | VerticalAlignment=‘Center’/> |
| 15 | <AppBarButton x:Name=‘VolumeMuteButton’ |
| 16 | Icon=‘Volume’ |
| 17 | Style=‘{StaticResource AppBarButtonStyle}’ |
| 18 | MediaTransportControlsHelper.DropoutPriority=‘3’ |
| 19 | VerticalAlignment=‘Center’/> |
| 20 | <AppBarButton x:Name=‘FullWindowButton’ |
| 21 | Icon=‘FullScreen’ |
| 22 | Style=‘{StaticResource AppBarButtonStyle}’ |
| 23 | MediaTransportControlsHelper.DropoutPriority=‘4’ |
| 24 | VerticalAlignment=‘Center’/> |
| 25 | <AppBarButton x:Name=‘ZoomButton’ |
| 26 | Icon=‘ZoomIn’ |
| 27 | Style=‘{StaticResource AppBarButtonStyle}’ |
| 28 | MediaTransportControlsHelper.DropoutPriority=‘5’ |
| 29 | VerticalAlignment=‘Center’/> |
| 30 | <AppBarButton x:Name=‘CCSelectionButton’ |
| 31 | Icon=‘ClosedCaption’ |
| 32 | Style=‘{StaticResource AppBarButtonStyle}’ |
| 33 | MediaTransportControlsHelper.DropoutPriority=‘6’ |
| 34 | VerticalAlignment=‘Center’/> |
| 35 | </CommandBar.PrimaryCommands> |
| 36 | </ControlTemplate> |
| 37 | </Style”> |

It can be seen, for example, that lines 5-9 related to a play/pause button (see line 5), and that line 8 assigns to a DropoutPriority data member for the play/pause button the value 1, which corresponds to priority value 1 in row 601 of FIG. 6.

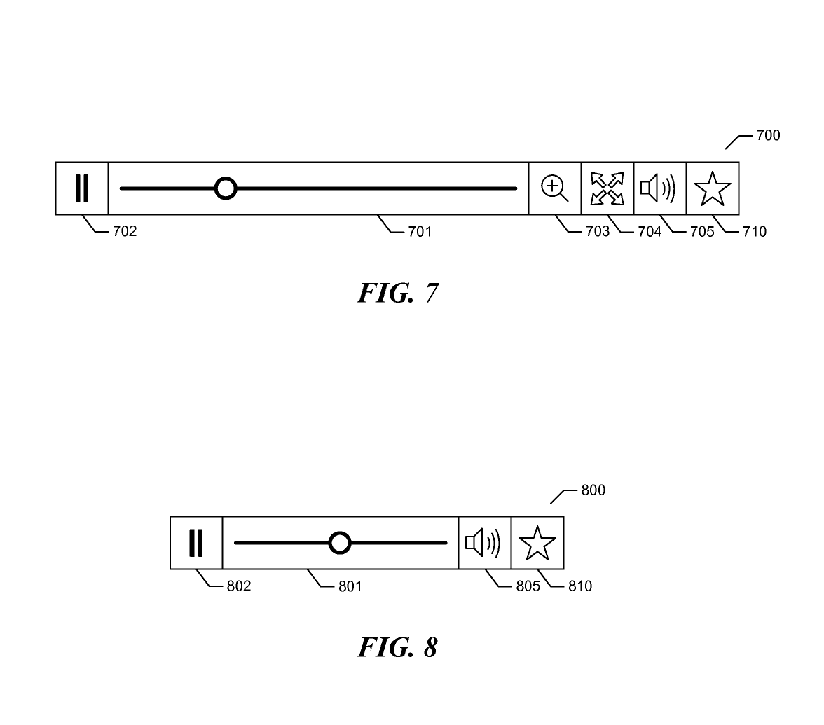

FIG. 7 is a display diagram showing media player controls presented in accordance with the precedence established in FIG. 6 and Table 5 when a relatively large amount of display space is available for controls, such as on a large display device, where much or all of the display area of the display device available to display media player controls. It can be seen that these controls 700 include the controls that have been assigned the six highest positions in the precedence order—i.e., priority values 1-6 shown in rows 601-606 of FIG. 6: a play/pause button 702, an audio effects button 710, a volume/mute button 705, a seek bar, a full window button 704, and a zoom button 703.

FIG. 8 is a display diagram showing the presentation of media player controls in accordance with the control precedence shown in FIG. 6 and in Table 5 in a case where a relatively small amount of display space is available, such as on a device having a small display device or a display where only a small portion of the display is allocated to display of media play controls. The controls 800 include the four highest controls in the precedence order—i.e., the controls having priority values 1-4 in rows 601-604 of FIG. 6: play/pause button 802, audio effects button 810, volume/mute button 805, and seek bar 801.

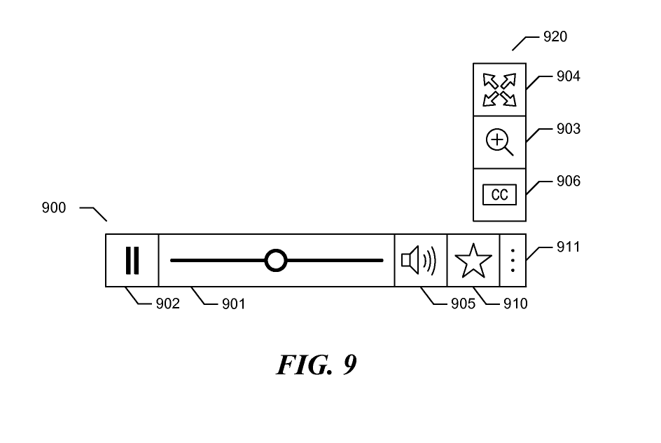

FIG. 9 is a display diagram showing the media player controls of FIG. 9 where the facility provides a secondary mechanism to present lower-precedence controls not presented among the main controls. It can be seen that controls 900, in addition to primary controls 901, 902, 905, and 910 shown in FIG. 8, also include an ellipsis control 911. When the ellipsis control 911 is selected by the user, such as by clicking on it, hovering over it, touching it, etc., the facility displays secondary controls 920. These secondary controls include the remaining controls in the precedence order having priority values 5-7 and shown in rows 605-607 of FIG. 6: the full window button 904, the zoom button 903, and the closed captioning selection button 906.

In some examples, the facility provides a device, comprising: a processor configured to execute an application; a media player control customization subsystem configured to receive from the application executed by the processor media player control customization directives; and a display interface configured to cause a display device to display a media player that includes media player controls presented in accordance with media player control customization directives received by the media player control customization subsystem.

In some examples, the facility provides a method in a computing system for managing a media player, the method comprising: discerning direction from an application program specifying a presentation of media player controls for the media player; and based at least in part on the discerning, causing to be displayed a visual user interface for the media player in which media player controls are presented in accordance with the discerned direction.

In some examples, the facility provides a computer-readable medium having contents configured to cause a computing system to, in order to operate in media player: discern direction from an application program specifying a presentation of media player controls for the media player; and based at least in part on the discerning, cause to be displayed the media player including a visual user interface for the media player in which media player controls are presented in accordance with the discerned direction.

It will be appreciated by those skilled in the art that the above-described facility may be straightforwardly adapted or extended in various ways. While the foregoing description makes reference to particular examples, the scope of the invention is defined solely by the claims that follow and the elements recited therein.

We claim:

1. A device, comprising:
a processor configured to execute an application;
a media player control customization subsystem configured to receive from the application executed by the processor media player control customization directives; and
a display interface configured to cause a display device to display a media player that includes media player controls presented in accordance with media player control customization directives received by the media player control customization subsystem.

2. The device of claim 1 wherein the device is of a type selected from among a television, a gaming console, a computer system, a tablet, a smart phone, a watch, a virtual reality display, and an augmented reality display.

3. A method in a computing system for managing a media player, the method comprising:
discerning direction from an application program specifying a presentation of media player controls for the media player; and
based at least in part on the discerning, causing to be displayed a visual user interface for the media player in which media player controls are presented in accordance with the discerned direction.

4. The method of claim 3 wherein the discerning comprises determining that the application program has invoked a function associated with the media player.

5. The method of claim 3 wherein the discerning comprises determining that the application program has assigned a value to a data member associated with the media player.

6. The method of claim 3 wherein the discerning comprises determining that the application program has provided a markup language template associated with the media player.

7. The method of claim 3 wherein the media player controls are presented in an arrangement specified by the discerned direction.

8. The method of claim 3 wherein the media player controls are presented in a number of rows specified by the discerned direction.

9. The method of claim 3 wherein the presented media player controls include a control specified by the discerned direction that can be activated to perform an action specified by the discerned direction.

10. The method of claim 3 wherein the presented media player controls omit a control specified by the discerned direction.

11. The method of claim 3 wherein the discerned direction specifies a precedence order among a plurality of media player controls supported by the media player,
the method further comprising:
based at least in part on the precedence order specified by the discerned direction, based at least in part on a display area size available for displaying media player controls, selecting a proper subset of the plurality of media player controls,
and wherein the presentation of media player controls presents only media player controls of the selected subset.

12. The method of claim 11 wherein all of the media player controls of the plurality that are selected occur earlier in the precedence order specified by the discerned direction than all of the media player controls of the plurality that are not selected.

13. The method of claim 11, further comprising making available via a secondary mechanism at least a portion of the media player controls of the plurality that are not in the selected subset.

14. A computer-readable medium having contents configured to cause a computing system to, in order to operate in media player:
discern direction from an application program specifying a presentation of media player controls for the media player; and
based at least in part on the discerning, cause to be displayed the media player including a visual user interface for the media player in which media player controls are presented in accordance with the discerned direction.

15. The computer readable medium of claim 14 wherein the contents of the computer-readable medium further cause the computing system to:
determine a size of a display region available for displaying media player controls; and
determine a presentation of media player controls based at least in part on the discerning, and based at least in part on the determined size.

16. The computer readable medium of claim 14 wherein the contents of the computer-readable medium further cause the computing system to:
without updating the application program, updating a software component installed on the computing system in a way that alters how the media player is displayed.

17. The computer readable medium of claim 16 wherein an operating system is installed on the computing system,
and wherein the software component is updated by a mechanism configured to update the operating system.

18. The computer readable medium of claim 14 wherein an operating system is installed on the computing system,
and wherein the discerning is based in part on one or more calls made by the application program to an API exposed by the operating system.

19. The computer readable medium of claim 14 wherein the contents of the computer-readable medium cause the computing system to perform the discerning and the causing to be displayed for each of a first application program and the second application program,
and wherein the direction discerned from the first application program is inconsistent with the direction discerned from the second application program,
and wherein the presentation of media player controls of the visual interface for the second application program differs from the presentation of media player controls of the visual interface for the first application program.

20. The computer readable medium of claim 14 wherein the presented media player controls include a control specified by the discerned direction.
